(19) United States
(12) Patent Application Publication
(10) Pub. No.: US 2012/0245248 A1
(43) Pub. Date: Sep. 27, 2012

(54) SILICONE HYDROGELS FORMED FROM REACTION MIXTURES FREE OF HYDROPHILIC MONOMERS

(76) Inventor: Azaam Alli, Jacksonville, FL (US)

(21) Appl. No.: 13/491,904

(22) Filed: Jun. 8, 2012

Related U.S. Application Data
(63) Continuation-in-part of application No. 13/430,839, filed on Mar. 27, 2012.
Application No. 13/430,839 is a division of application No. 12/630,219, filed on Dec. 3, 2009, now Pat. No. 8,168,720.
Application No. 12/630,219 is a division of application No. 10/938,361, filed on Sep. 10, 2004, now Pat. No. 7,666,921.
Application No. 10/938,361 is a division of application No. 10/236,538, filed on Sep. 6, 2002, now Pat. No. 6,822,016.
(60) Provisional application No. 60/318,536, filed on Sep. 10, 2001.

(51) Int. Cl. C08L 83/07; C08K 5/09

(52) U.S. Cl. 523/107

(57) ABSTRACT

The present invention relates to silicone hydrogels formed from mixtures comprising one or more hydrophilic high molecular weight polymers, one or more hydroxyl-functionalized silicone containing monomers, one or more crosslinkers and a compatabilizing diluent, but without a substantial amount of a reactive hydrophilic monomer or macromer.

### RELATED PATENT APPLICATIONS

This patent application is a continuation in part of U.S. Ser. No. 13/430,839 filed on Mar. 27, 2012, which is a divisional of U.S. Ser. No. 12/630,219 filed on Dec. 3, 2009, now U.S. Pat. No. 8,168,720, which was a divisional of U.S. Ser. No. 10/938,361 filed on Sep. 10, 2004, now U.S. Pat. No. 7,666,921 which was a divisional of U.S. Ser. No. 10/236,538 filed on Sep. 6, 2002, now U.S. Pat. No. 6,822,016, which claimed priority of provisional application, U.S. Ser. No. 60/318,536 filed on Sep. 10, 2001.

### FIELD OF THE INVENTION

This invention relates to silicone hydrogels that contain internal wetting agents, as well as methods for their production and use.

### BACKGROUND OF THE INVENTION

Contact lenses have been used commercially to improve vision since at least the 1950s. The first contact lenses were made of hard materials and as such were somewhat uncomfortable to users. Modern lenses have been developed that are made of softer materials, typically hydrogels and particularly silicone hydrogels. Silicone hydrogels are water-swollen polymer networks that have high oxygen permeability and surfaces that are more hydrophobic than hydrophilic. These lenses provide a good level of comfort to many lens wearers, but there are some users who experience discomfort and excessive ocular deposits leading to reduced visual acuity when using these lenses. This discomfort and deposits has been attributed to the hydrophobic character of the surfaces of lenses and the interaction of those surfaces with the protein, lipids and mucin and the hydrophilic surface of the eye.

Others have tried to alleviate this problem by coating the surface of silicone hydrogel contact lenses with hydrophilic coatings, such as plasma coatings

Incorporating internal hydrophilic agents (or wetting agents) into a silicone hydrogel formulations has been disclosed. However, not all silicone containing macromers display compatibility with hydrophilic polymers. Modifying the surface of a polymeric article by adding polymerizable surfactants to a monomer mix used to form the article has also been disclosed. However, lasting in vivo improvements in wettability and reductions in surface deposits are not likely.

Polyvinylpyrrolidone (PVP) or poly-2-ethyl-2-oxazoline have been added to hydrogel compositions to form an interpenetrating network which shows a low degree of surface friction, a low dehydration rate and a high degree of biodeposit resistance.

While it may be possible to incorporate high molecular weight polymers as internal wetting agents into silicone hydrogel lenses, such polymers are difficult to solubilize in reaction mixtures which contain silicones and hydrophilic monomers. In order to solubilize these wetting agents, silicone macromers or other prepolymers must be used. These silicone macromers or prepolymers must be prepared in a separate step and then subsequently mixed with the remaining ingredients of the silicone hydrogel formulation. This additional step (or steps) increases the cost and the time it takes to produce these lenses.

Silicone hydrogels have been prepared by polymerizing mixtures containing at least one silicone containing monomer and at least one hydrophilic monomer. Either the silicone containing monomer or the hydrophilic monomer may function as a crosslinking agent or a separate crosslinking agent may be employed. However, if hydrophilic monomers or macromers are not included in such mixtures, then after hydration the water content of the final polymer is too low to be useful for forming contact lenses.

Thus, there still remains a need in the art for silicone hydrogels which are formed from mixtures that do not include hydrophilic monomers and/or macromers, and yet have adequate water content to be used to form contact lenses. A further benefit of the present invention is that it produces silicone hydrogel lenses which may not need surface modification for surface wettability.

### SUMMARY OF THE INVENTION

The present invention relates to mixture for forming silicone hydrogels, these mixtures consisting essentially of one or more non-reactive, hydrophilic high molecular weight polymers, one or more hydroxyl-functionalized silicone containing monomers, one or more crosslinkers, and at least one compatabilizing diluent.

Still further the present invention relates to methods for manufacturing devices, specifically ophthalmic devices and more specifically contact lenses and the articles so made. The present invention comprises contact lenses which may not be surface treated and are sufficiently wettable to be worn without substantial irritation to the eye.

### DETAILED DESCRIPTION OF THE SPECIFIC EMBODIMENTS

As used herein the term “hydroxyl-functionalized silicone containing monomer” means reaction components which contain at least one silicone and at least one hydroxyl group, in which the ratio of Si atoms to OH groups is less than about 15 to 1. Such components have been disclosed in U.S. Pat. No. 6,822,016 and US2011-0237766. For the present invention, silicone containing compatibilizing agents, if polymerized only in the presence of a small amount of a crosslinker, form polymers which when hydrated contain less than 10% water by weight. Hydroxyl functionality is very efficient at improving hydrophilic compatibility. Thus, in a preferred embodiment hydroxyl-functionalized silicone containing monomers of the present invention comprise at least one hydroxyl group and at least one “—Si—O—Si—” group.

As used herein, “compatibilizing diluent” refers to a diluent which is capable of producing a clear reactive mixture when combined with the silicone, hydroxyl functional silicone-containing monomer and non-reactive high molecular weight hydrophilic polymer, and producing an optically clear final hydrated lens. Diluents do not react to form part of the biomedical devices.

As used herein, a “biomedical device” is any article that is designed to be used while either in or on mammalian tissues or fluid, and preferably in or on human tissue or fluids. Examples of these devices include but are not limited to catheters, implants, stents, and ophthalmic devices such as intraocular lenses and contact lenses. The preferred biomedical devices are ophthalmic devices, particularly contact lenses, most particularly contact lenses made from silicone hydrogels.

As used herein, the terms “lens” and “ophthalmic device” refer to devices that reside in or on the eye. These devices can provide optical correction, wound care, drug delivery, diagnostic functionality, cosmetic enhancement or effect or a combination of these properties. The term lens includes but is not limited to soft contact lenses, hard contact lenses, intraocular lenses, overlay lenses, ocular inserts, and optical inserts.

As used herein the term “monomer” is a compound containing at least one polymerizable group and an average molecular weight of about less than 2000 Daltons, as measure via gel permeation chromatography refractive index detection. Thus, monomers include dimers and in some cases oligomers, including oligomers made from more than one monomeric unit.

As used herein, the phrase “without a surface treatment” means that the exterior surfaces of the devices of the present invention are not separately treated to improve the wettability of the device. Treatments which may be foregone because of the present invention include, plasma treatments, grafting, coating and the like. However, coatings which provide properties other than improved wettability, such as, but not limited to antimicrobial coatings may be applied to devices of the present invention.

Various molecular weight ranges are disclosed herein. For compounds having discrete molecular structures, the molecular weights reported herein are calculated based upon the molecular formula and reported in gm/mol. For polymers molecular weights (number average) are measured via gel permeation chromatography refractive index detection and reported in Daltons or are measured via kinematic viscosity measurements, as described in Encyclopedia of Polymer Science and Engineering, N-Vinyl Amide Polymers, Second edition, Vol. 17, pgs. 198-257, John Wiley & Sons Inc. and reported in K-values.

All percentages in this specification are weight percentages unless otherwise noted.

As used herein, the term “consisting essentially of” means that the reactive mixtures contain the recited components, but are substantially free from reactive hydrophilic components, including monomers, prepolymers, and macromers. The term consisting essentially of may include additional components, which do not substantially alter the hydrophilic nature of the reaction mixture or resulting polymer. Such additional components may include crosslinkers (in amounts less than about 5 wt %), UV absorbers, tints, colorants, pigments, dyes (including spectral filter dyes), pharmaceutical and nutriceutical compounds, photochromic compounds, combinations thereof and the like.

As used herein, “non-reactive” means not containing a polymerizable group, such that the component is not covalently bound to the silicone polymer network.

As used herein, “hydrophilic components” are those which, when mixed, at 25° C. in a 1:1 ratio by volume with neutral, buffered water (pH about 7.0) forms a homogenous solution. Any of the reactive hydrophilic monomers known to be useful to make hydrogels may be excluded from the formulations of the present invention.

For a contact lens, “wettable” is a lens which displays an advancing dynamic contact angle of less than about 80°, preferably less than 70° and more preferably less than about 60°.

The present invention relates to silicone hydrogel reactive mixtures which are substantially free from reactive hydrophilic components. In one embodiment the reaction mixtures consist essentially of one or more non-reactive, hydrophilic high molecular weight polymers, one or more hydroxyl-functionalized silicone containing monomers, one or more crosslinkers, and at least one compatabilizing diluent.

### Non-Reactive, High Molecular Weight Hydrophilic Polymer

As used herein, “non-reactive, high molecular weight hydrophilic polymer” refers to polymers having a weight average molecular weight of no less than about 100,000 Daltons, wherein said polymers upon incorporation to silicone hydrogel formulations, increase the wettability of the cured silicone hydrogels. The preferred weight average molecular weight of these non-reactive, high molecular weight hydrophilic polymers is greater than about 150,000; more preferably between about 150,000 to about 2,000,000 Daltons, more preferably still between about 300,000 to about 1,800,000 Daltons, most preferably about 500,000 to about 1,500,000 Daltons.

Alternatively, the molecular weight of hydrophilic polymers of the invention can be also expressed by the K-value, based on kinematic viscosity measurements, as described in Encyclopedia of Polymer Science and Engineering, N-Vinyl Amide Polymers, Second edition, Vol. 17, pgs. 198-257, John Wiley & Sons Inc. When expressed in this manner, hydrophilic monomers having K-values of greater than about 46 and preferably between about 46 and about 150. The non-reactive, high molecular weight hydrophilic polymers are present in the formulations of these devices in amounts sufficient to provide hydrogels having at least about 20% water. Suitable amounts of high molecular weight hydrophilic polymer include between about 14 to about 25 weight %, and in some embodiments between about 15 to about 25 weight %.

The biomedical device of the present invention may further comprise a second hydrophilic polymer having a molecular weight less than about 50,000 Daltons.

The non-reactive high molecular weight hydrophilic polymers do not contain polymerizable groups, and are not covalently bound to the silicone polymer network during curing. Instead the non-reactive high molecular weight hydrophilic polymers are held in the polymer network via entrapment.

Suitable amounts of high molecular weight hydrophilic polymer include at least about 15 weight percent, in some embodiments from about 15 percent to about 30 weight percent and in other embodiments from about 15 to about 25 weight percent, all based upon the total of all reactive components.

Examples of high molecular weight hydrophilic polymers include, but are not limited to, polyamides, polylactones, polyimides, and polylactams. In one embodiment, non-reactive high molecular weight hydrophilic polymers contain a cyclic moiety in their backbone, more preferably, a cyclic amide or cyclic imide. Non-reactive, high molecular weight hydrophilic polymers include but are not limited to poly-N-vinyl pyrrolidone, poly-N-vinyl-2-piperidone, poly-N-vinyl-2-caprolactam, poly-N-vinyl-3-methyl-2-caprolactam, poly-N-vinyl-3-methyl-2-piperidone, poly-N-vinyl-4-methyl-2-piperidone, poly-N-vinyl-4-methyl-2-caprolactam, poly-N-vinyl-3-ethyl-2-pyrrolidone, poly-N-vinyl-4,5-dimethyl-2-pyrrolidone, polyvinylimidazole, poly-N—N-dimethylacrylamide, polyvinyl alcohol, polyacrylic acid, polyethylene oxide, poly-2-ethyl oxazoline, poly-N-vinyl-N-methylacetamide, heparin polysaccharides, polysaccharides, mixtures and copolymers (including block or random, branched, multichain, comb-shaped or star shaped) thereof where poly-N-vinylpyrrolidone (PVP) is in one embodiment, particularly preferred. Copolymers might also be used such as graft copolymers of PVP.

The non-reactive, high molecular weight hydrophilic polymers provide improved wettability, and particularly improved in vivo wettability to the medical devices of the present invention. Without being bound by any theory, it is believed that the high molecular weight hydrophilic polymers are hydrogen bond receivers which in aqueous environments, hydrogen bond to water, thus becoming effectively more hydrophilic. The absence of water facilitates the incorporation of the hydrophilic polymer in the reaction mixture. Aside from the specifically named high molecular weight hydrophilic polymers, it is expected that any high molecular weight polymer will be useful in this invention provided that when said polymer is added to a silicone hydrogel formulation, the hydrophilic polymer (a) does not substantially phase separate from the reaction mixture and (b) imparts wettability to the resulting cured polymer. In some embodiments it is preferred that the high molecular weight hydrophilic polymer be soluble in the diluent at processing temperatures. Manufacturing processes which use water or water soluble diluents may be preferred due to their simplicity and reduced cost. In these embodiments high molecular weight hydrophilic polymers which are water soluble at processing temperatures are preferred.

### Hydroxyl-Functionalized Silicone Containing Monomer

As used herein a “hydroxyl-functionalized silicone containing monomer” is a compound containing at least one polymerizable group having an average molecular weight of about less than 5000 Daltons as measured via gel permeation chromatography, refractive index detection, and preferably less than about 3000 Daltons, which is capable of compatibilizing the silicone containing monomers included in the hydrogel formulation with the hydrophilic polymer. Hydroxyl functionality is very efficient at improving hydrophilic compatibility. Thus, in a preferred embodiment hydroxyl-functionalized silicone containing monomers of the present invention comprise at least one hydroxyl group and at least one “—Si—O—Si—” group. It is preferred that silicone and its attached oxygen account for more than about 10 weight percent of said hydroxyl-functionalized silicone containing monomer, more preferably more than about 20 weight percent.

The ratio of Si to OH in the hydroxyl-functionalized silicone containing monomer is also important to providing a hydroxyl functionalized silicone containing monomer which will provide the desired degree of compatibilization. If the ratio of hydrophobic portion to OH is too high, the hydroxyl-functionalized silicone monomer may be poor at compatibilizing the hydrophilic polymer, resulting in incompatible reaction mixtures. Accordingly, in some embodiments, the Si to OH ratio is less than about 15:1, and preferably between about 1:1 to about 10:1. In some embodiments primary alcohols have provided improved compatibility compared to secondary alcohols. Those of skill in the art will appreciate that the amount and selection of hydroxyl-functionalized silicone containing monomer will depend on how much hydrophilic polymer is needed to achieve the desired wettability and the degree to which the silicone containing monomer is incompatible with the hydrophilic polymer.

In one embodiment, examples of hydroxyl-functionalized silicone containing monomers include monomers of Formulae I and II

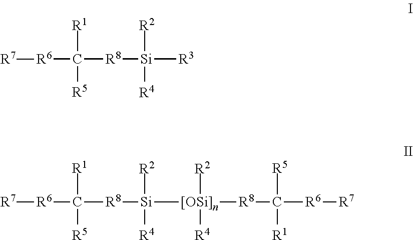

wherein:

n is an integer between 3 and 35, and preferably between 4 and 25;

R¹ is hydrogen, C₁₋₆alkyl;
R², R³, and R⁴, are independently, C₁₋₆alkyl, triC₁₋₆alkylsiloxy, alkyl terminated polyalkyl siloxane having up to 10 SiO repeating units, phenyl, naphthyl, substituted C₁₋₆alkyl, substituted phenyl, or substituted naphthyl
where the alkyl substitutents are selected from one or more members of the group consisting of C₁₋₆alkoxycarbonyl, C₁₋₆alkyl, C₁₋₆alkoxy, amide, halogen, hydroxyl, carboxyl, C₁₋₆alkylcarbonyl and formyl, and
where the aromatic substitutents are selected from one or more members of the group consisting of C₁₋₆alkoxycarbonyl, C₁₋₆alkyl, C₁₋₆alkoxy, amide, halogen,
   In one embodiment, for monofunctional hydroxyl, carboxyl, C₁₋₆alkylcarbonyl and formyl;

R⁵ is hydroxyl, an alkyl group containing one or more hydroxyl groups; or) (CH₂(CR⁹R¹⁰)_{y}O)ₓ)—R¹¹ wherein y is 1 to 5, preferably 1 to 3, x is an integer of 1 to 100, preferably 2 to 90 and more preferably 10 to 25; R⁹— R^{H} are independently selected from H, alkyl having up to 10 carbon atoms and alkyls having up to 10 carbon atoms substituted with at least one polar functional group,

R⁶ is a divalent group comprising up to 20 carbon atoms;

R⁷ is a monovalent group that can under free radical and/or cationic polymerization and comprising up to 20 carbon atoms

R⁸ is a divalent or trivalent group comprising up to 20 carbon atoms.

Reaction mixtures of the present invention may include more than one hydroxyl-functionalized silicone containing monomer.

In one embodiment hydroxyl functionalized silicone containing monomer of Formula I R¹ is hydrogen, and R², R³, and R⁴, are independently C₁₋₆alkyl and triC₁₋₆alkylsiloxy, alkyl terminated polyalkylsiloxane having 3 to 7 SiO repeating units. In another embodiment at least two of R², R³ and R⁴ are trimethylsiloxy, and the remaining R is methyl. In another embodiment one of R², R³ and R⁴ alkyl terminated polyalkylsiloxane having 3 to 7 SiO repeating units and the remaining R are methyl or ethyl.

For multifunctional (difunctional or higher) R¹-R⁴ independently comprise ethylenically unsaturated polymerizable groups and more preferably comprise an acrylate, a styryl, a C₁₋₆alkylacrylate, acrylamide, C₁₋₆alkylacrylamide, N-vinyllactam, N-vinylamide, C₂₋₁₂alkenyl, C₂₋₄₂alkenylphenyl, C₂₋₁₂alkenylnaphthyl, or C₂₋₆alkenylphenylC₁₋₆alkyl.

The preferred R⁵ is hydroxyl, —CH₂OH or CH₂CHOHCH₂OH, with hydroxyl being most preferred.

The preferred R⁶ is a divalent C₁₋₆alkyl, C₁₋₆alkyloxy, C₁₋₆alkyloxyC₁₋₆alkyl, phenylene, naphthalene, C₁₋₁₂cycloalkyl, C₁₋₆alkoxycarbonyl, amide, carboxy, C₁₋₆alkylcarbonyl, carbonyl, C₁₋₆alkoxy, substituted C₁₋₆alkyl, substituted C₁₋₆alkyloxy, substituted C₁₋₆alkyloxyC₁₋₆alkyl, substituted phenylene, substituted naphthalene, substituted C₁₋₁₂cycloalkyl, where the substituents are selected from one or more members of the group consisting of C₁₋₆alkoxycarbonyl, C₁₋₆alkyl, C₁₋₆alkoxy, amide, halogen, hydroxyl, carboxyl, C₁₋₆alkylcarbonyl and formyl. The particularly preferred R⁶ is a divalent methyl (methylene).

The preferred R⁷ comprises a free radical reactive group, such as an acrylate, a styryl, vinyl, vinyl ether, itaconate group, a C₁₋₆alkylacrylate, acrylamide, C₁₋₆alkylacrylamide, N-vinyllactam, N-vinylamide, C₂₋₁₂alkenyl, C₂₋₁₂alkenylphenyl, C₂₋₁₂alkenylnaphthyl, or C₂₋₆alkenylphenylC₁₋₆alkyl or a cationic reactive group such as vinyl ether or epoxide groups. The particularly preferred R⁷ is methacrylate.

The preferred R⁸ is a divalent C₁₋₆alkyl, C₁₋₆alkyloxy, C₁₋₆alkyloxyC₁₋₆alkyl, phenylene, naphthalene, C₁₋₁₂cycloalkyl, C₁₋₆alkoxycarbonyl, amide, carboxy, C₁₋₆alkylcarbonyl, carbonyl, C₁₋₆alkoxy, substituted C₁₋₆alkyl, substituted C₁₋₆alkyloxy, substituted C₁₋₆alkyloxyC₁₋₆alkyl, substituted phenylene, substituted naphthalene, substituted C₁₋₁₂cycloalkyl, where the substituents are selected from one or more members of the group consisting of C₁₋₆alkoxycarbonyl, C₁₋₆alkyl, C₁₋₆alkoxy, amide, halogen, hydroxyl, carboxyl, C₁₋₆alkylcarbonyl and formyl. The particularly preferred R⁸ is C₁₋₆alkyloxyC₁₋₆alkyl.

Examples of hydroxyl-functionalized silicone containing monomer of Formula I that are particularly preferred are 2-propenoic acid, 2-methyl-,2-hydroxy-3-[3-[1,3,3,3-tetramethyl-1-[(trimethylsilyl)oxy]disiloxanyl]propoxy]propyl ester (which can also be named (3-methacryloxy-2-hydroxypropyloxy)propylbis(trimethylsiloxy)methylsilane)

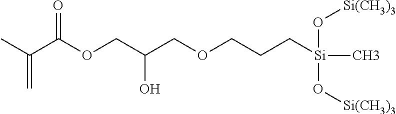

The above compound, (3-methacryloxy-2-hydroxypropyloxy)propylbis(trimethylsiloxy)methylsilane, also known as SiGMA, is typically formed from an epoxide, which produces an 80:20 mixture of the compound shown above and (2-methacryloxy-3-hydroxypropyloxy)propylbis(trimethylsiloxy)methylsilane. In some embodiments of the present invention it is preferred to have some amount of the primary hydroxyl present, preferably greater than about 10 wt % and more preferably at least about 20 wt %.

Other suitable hydroxyl-functionalized silicone containing monomers include (3-methacryloxy-2-hydroxypropyloxy)propyltris(trimethylsiloxy)silane

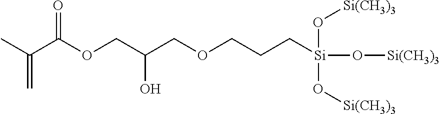

### bis-3-methacryloxy-2-hydroxypropyloxypropyl polydimethylsiloxane

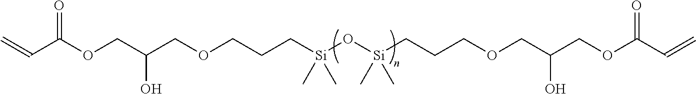

### 3-methacryloxy-2-(2-hydroxyethoxy)propyloxy)propylbis(trimethylsiloxy)methylsilane

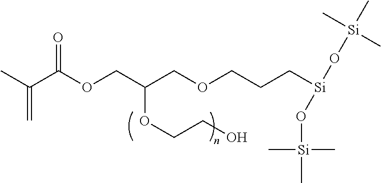

### N,N,N′,N′-tetrakis(3-methacryloxy-2-hydroxypropyl)-α,ω-bis-3-aminopropyl-polydimethylsiloxane

The reaction products of glycidyl methacrylate with amino-functional polydimethylsiloxanes may also be used as a hydroxyl-functional silicone containing monomer. Other suitable hydroxyl-functional silicone containing monomers include those disclosed in columns 6, 7 and 8 of U.S. Pat. No. 5,994,488, and monomers disclosed in 4,259,467; 4,260,725; 4,261,875; 4,649,184; 4,139,513, 4,139,692, US 2002/0016383, 4,139,513 and 4,139,692. These and any other patents or applications cited herein are incorporated by reference.

Still additional structures which may be suitable hydroxyl-functionalized silicone containing monomers include those similar to the compounds disclosed in Pro. ACS Div. Polym. Mat. Sci. Eng., Apr. 13-17, 1997, p. 42, and having the following structure:

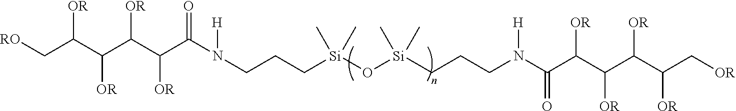

where n=1-50 and R independently comprise H or a polymerizable unsaturated group, with at least one R comprising a polymerizable group, and at least one R, and preferably 3-8R, comprising H.

Additional suitable hydroxyl-functionalized silicone containing monomers are disclosed in U.S. Pat. No. 4,235,985.

These components may be removed from the hydroxyl-functionalized monomer via known methods such as liquid phase chromatography, distillation, recrystallization or extraction, or their formation may be avoided by careful selection of reaction conditions and reactant ratios.

Still further hydroxyl functionalized silicone containing monomers include mono-(2-hydroxy-3-methacryloxypropyl)-propyl ether terminated polydimethylsiloxane (400-1000 MW)) and silicone (meth)acrylamide monomer comprising a (meth)acrylamide group, a straight chain siloxanyl group having two or more —OSi repeating units in a molecule at least one hydroxyl group.

The silicone (meth)acrylamide monomer may be expressed by the following general formula:

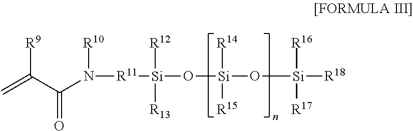

Wherein R⁹ represents a hydrogen atom or a methyl group;

R¹⁰ represents a hydrogen atom or an alkyl or an aryl group with between 1 and 20 carbon atoms which may be substituted with hydroxyl, acid, ester, ether, thiol and combinations thereof;

R¹¹ represents a C₁₋₁₀ alkylene group or arylene group that may be substituted with hydroxyl acid, ester, ether, thiol and combinations thereof; wherein at least one of either R¹⁰ or R¹¹ contains a hydroxyl group;

R¹² to R¹⁸ independently represent a C₁₋₂₀ alkyl group or an aryl group with between 1 and 20 carbon atoms, either of which may be substituted with fluorine, hydroxyl, acid, ester, ether, thiol and combinations thereof, and n is an integer in a range from 1 to 10.

In another embodiment the hydroxyl functionalized silicone containing monomer is a hydroxyl functionalized polydialkyl siloxane, and in another embodiment is a mono (meth)acrylate or (meth)acrylamide terminated, hydroxyl functionalized polydialkyl siloxane. Examples of mono (meth)acrylamide terminated, hydroxyl functionalized polydialkyl siloxane include those shown in Formulae IV through V.

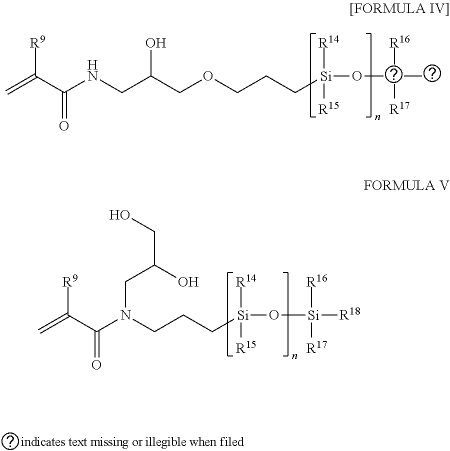

In the chemical formulae IV-V, R⁹ independently represents a hydrogen atom or a methyl group. Of these, hydrogen atoms are more preferable from the perspective of increasing the polymerization rate.

R¹⁴ to R¹⁸ independently represent alkyl groups having between 1 and 20 carbon atoms or aryl groups having between 6 and 20 carbon atoms. If the number of carbon atoms of R¹⁴ through R¹⁷ is too high, a silicon atom content will be relatively low, leading to a reduction in the oxygen permeability of the silicone hydrogel. Therefore an alkyl group with between 1 and 10 carbon atoms or an aryl group with between 6 and 10 carbon atoms is more preferable, and alkyl group with between 1 and 4 carbon atoms is even more preferable, and a methyl group is most preferable. If the number of carbon atoms in R¹⁸ is too low, the polysiloxane chain will easily hydrolyze, but if too high, the silicone hydrogel will tend to have lower oxygen permeability. Therefore, an alkyl group with between 1 and 10 carbon atoms or an aryl group with between 6 and 10 carbon atoms is more preferable, an alkyl group with between 1 and 6 carbon atoms is even more preferable, and an alkyl group with between 1 and 4 carbon atoms is most preferable.

In another embodiment, the hydroxyl functionalized silicone containing monomer comprises a (meth)acrylamide of Formulae VI or VII.

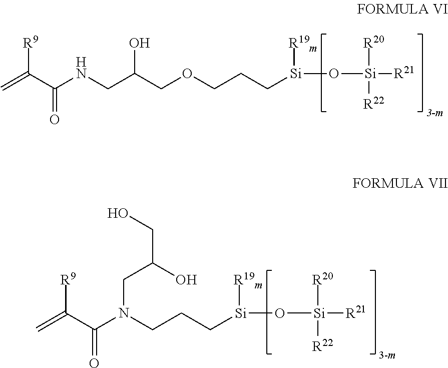

If the number of carbon atoms in R¹⁹ through R²² is too high, the oxygen permeability of the silicone hydrogel will be reduced, and therefore an alkyl group between 1 and 10 carbon atoms or an aryl group with between 6 and 10 carbon atoms is more preferable, an alkyl group with between 1 and 4 carbon atoms is even more preferable, and a methyl group or ethyl group is most preferable.

n is a natural number in the range from 1 to 50. If n is too small, oxygen permeability of the resulting hydrogel is decreased, but if too large, a compatibility with the high molecular weight hydrophilic polymer is decreased. Therefore a value between 2 and 30 is desirable, and between 3 and 10 is preferable.

m represents a natural number from 0 to 2; and is more preferably 0 or 1 in order to obtain sufficient oxygen permeability. Mono(meth)acrylamide terminated, hydroxyl functionalized polydialkyl siloxane may be made using the processes disclosed in US2011-0237766.

Suitable multifunctional hydroxyl-functionalized silicone monomers are commercially available from Gelest, Inc, Morrisville, Pa. or may be made using the procedures disclosed in 5,994,488, 5,962,548, US2006-0229423 and US2011-0237766. Suitable PEG type hydroxyl-functionalized silicone monomers may be made using the procedures disclosed in PCT/JP02/02231.

An “effective amount” or a “compatibilizing effective amount” of the hydroxyl-functionalized silicone-containing monomers of the invention is the amount needed to compatibilize or dissolve the high molecular weight hydrophilic polymer and the other components of the polymer formulation. Thus, the amount of hydroxyl-functional silicone containing monomer will depend in part on the amount of hydrophilic polymer which is used, with more hydroxyl-functionalized silicone containing monomer being needed to compatibilize higher concentrations of hydrophilic polymer. Effective amounts of hydroxyl-functionalized silicone containing monomer in the polymer formulation include about 40% (weight percent, based on the weight percentage of the reactive components) to about 80%, preferably about 50% to about 75%.

### Compatibilizing Diluent

Suitable compatibilizing diluents include those, which possess both a hydrophilic and a hydrophobic nature. It has been found that the hydrophilic nature may be characterized by hydrogen donating ability, using Kamlet alpha values (also referred to as alpha values). The hydrophobic nature of the diluent may be characterized by the Hansen solubility parameter δp. Suitable diluents for the present invention are good hydrogen bond donors and polar. As used herein a “good” hydrogen bond donor, will donate hydrogen at least as readily as 3-methyl-3-pentanol. For certain diluents it is possible to measure the hydrogen bond donating ability by measuring the Kamlet alpha value (or as used herein “alpha value”). Suitable alpha values include those between about 0.05 and about 1 and preferably between about 0.1 and about 0.9. See EP1601723.

The diluents useful in the present invention should also be relatively non-polar. The selected diluent should have a polarity sufficiently low to solubilize the non-polar components in the reactive mixture at reaction conditions. One way to characterize the polarity of the diluents of the present invention is via the Hansen solubility parameter, δp. In certain embodiments, the δp is less than about 10, and preferably less than about 6. FIG. 1 depicts the Hansen p and alpha values for various diluents. Blends are the compositions used to form lenses before the compositions are cured, as would be understood by one of ordinary skill in the art.

Specific diluents which may be used include, without limitation, 1-ethoxy-2-propanol, diisopropylaminoethanol, isopropanol, 3,7-dimethyl-3-octanol, 1-decanol, 1-dodecanol, 1-octanol, 1-pentanol, 2-pentanol, 1-hexanol, 2-hexanol, 2-octanol, 3-methyl-3-pentanol, tert-amyl alcohol, tert-butanol, 2-butanol, 1-butanol, 2-methyl-2-pentanol, 2-propanol, 1-propanol, ethanol, 2-ethyl-1-butanol, SiGMA acetate, 1-tert-butoxy-2-propanol, 3,3-dimethyl-2-butanol, tert-butoxyethanol, 2-octyl-1-dodecanol, decanoic acid, octanoic acid, dodecanoic acid, 2-(diisopropylamino)ethanol mixtures thereof and the like.

Classes of suitable diluents include, without limitation, alcohols having 2 to 20 carbons, amides having 10 to 20 carbon atoms derived from primary amines and carboxylic acids having 8 to 20 carbon atoms. In some embodiments, primary and tertiary alcohols are preferred. Preferred classes include alcohols having 5 to 20 carbons and carboxylic acids having 10 to 20 carbon atoms.

Preferred diluents include 3,7-dimethyl-3-octanol, 1-dodecanol, 1-decanol, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, 2-methyl-2-pentanol, 2-ethyl-1-butanol, ethanol, 3,3-dimethyl-2-butanol, 2-octyl-1-dodecanol, decanoic acid, octanoic acid, dodecanoic acid, mixtures thereof and the like.

More preferred diluents include 3,7-dimethyl-3-octanol, 1-dodecanol, 1-decanol, 1-octanol, 1-pentanol, 1-hexanol, 2-hexanol, 2-octanol, 1-dodecanol, 3-methyl-3-pentanol, 1-pentanol, 2-pentanol, t-amyl alcohol, tert-butanol, 2-butanol, 1-butanol, 2-methyl-2-pentanol, 2-ethyl-1-butanol, 3,3-dimethyl-2-butanol, 2-octyl-1-dodecanol, mixtures thereof and the like.

Mixtures of diluents may be used. In some embodiments it may be advantageous to use diluents with different properties. Moreover, it should be appreciated that when mixtures are used, the mixtures may include a diluent with properties within those specified herein and diluent(s) which do not possess the defined properties, or may contain diluents which each contain only one of the specified properties, so long as the alpha value and the δp of the diluent mixture is within the values specified herein.

The diluents may be used in amounts up to about 50% by weight of the total of all components in the reactive mixture. More preferably the diluent is used in amounts less than about 45% and more preferably in amounts between about 15 and about 40% by weight of the total of all components in the reactive mixture.

In addition to the high molecular weight hydrophilic polymers and the hydroxyl-functionalized silicone containing monomers of the invention other hydrophilic and hydrophobic monomers, crosslinkers, additives, diluents, polymerization initators may be used to prepare the biomedical devices of the invention. In addition to high molecular weight hydrophilic polymer and hydroxyl-functionalized silicone containing monomer, the hydrogel formulations may include additional silicone containing monomers, hydrophilic monomers, and cross linkers to give the biomedical devices of the invention.

### Additional Silicone Containing Monomers

Non-compatabilizing silicone containing components may optionally be included in the lens forming mixture as additional silicone-containing monomers.

With respect to the additional silicone containing monomers, amide analogs of TRIS described in U.S. Pat. No. 4,711,943, vinylcarbamate or carbonate analogs described in U.S. Pat. No. 5,070,215, and siloxane containing monomers contained in U.S. Pat. No. 6,020,445 are useful and these aforementioned patents as well as any other patents mentioned in this specification are hereby incorporated by reference. More specifically, 3-methacryloxypropyltris(trimethylsiloxy)silane (TRIS), monomethacryloxypropyl, n-alkyl terminated polydimethylsiloxanes, polydimethylsiloxanes, 3-methacryloxypropylbis(trimethylsiloxy)methylsilane, methacryloxypropylpentamethyl disiloxane and combinations thereof are particularly useful as additional silicone-containing monomers of the invention. Any other silicone-containing monomer known in the art may be included as additional silicone containing monomers, so long as they do not include blocks of hydrophilic units. Additional silicone containing monomers may be present in amounts of about 0 to about 30 wt %.

A silicone containing component is one that contains at least one [—Si—O—Si] group, in a monomer, macromer or prepolymer. Preferably, the Si and attached 0 are present in the silicone containing component in an amount greater than 20 weight percent, and more preferably greater than 30 weight percent of the total molecular weight of the silicone containing component. Useful silicone containing components preferably comprise polymerizable functional groups such as acrylate, methacrylate, acrylamide, methacrylamide, N-vinyl lactam, N-vinylamide, and styryl functional groups. Examples of silicone containing components which are useful in this invention may be found in U.S. Pat. Nos. 3,808,178; 4,120,570; 4,136,250; 4,153,641; 4,740,533; 5,034,461 and 5,070,215, and EP080539. All of the patents cited herein are hereby incorporated in their entireties by reference. These references disclose many examples of olefinic silicone containing components.

Further examples of suitable additional silicone containing monomers are polysiloxanylalkyl(meth)acrylic monomers represented by the following formula:

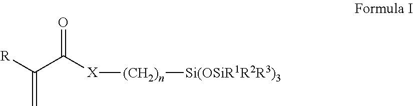

wherein: R denotes H or lower alkyl; X denotes O or NR⁴; each R⁴ independently denotes hydrogen or methyl,
each R¹-R³ independently denotes a lower alkyl radical or a phenyl radical, and
n is 1 or 3 to 10.

Examples of these polysiloxanylalkyl (meth)acrylic monomers include methacryloxypropyl tris(trimethylsiloxy) silane, pentamethyldisiloxanyl methylmethacrylate, and methyldi(trimethylsiloxy)methacryloxymethyl silane. Methacryloxypropyl tris(trimethylsiloxy)silane is the most preferred. One preferred class of non-compatabilizing silicone containing components is a poly(organosiloxane) prepolymer represented by formula II:

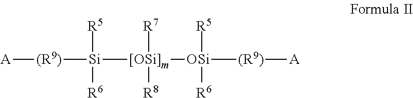

wherein each A independently denotes an activated unsaturated group, such as an ester or amide of an acrylic or a methacrylic acid or an alkyl or aryl group (providing that at least one A comprises an activated unsaturated group capable of undergoing radical polymerization); each of R⁵, R⁶, R⁷ and R⁸ are independently selected from the group consisting of a monovalent hydrocarbon radical or a halogen substituted monovalent hydrocarbon radical having 1 to 18 carbon atoms which may have ether linkages between carbon atoms;
R⁹ denotes a divalent hydrocarbon radical having from 1 to 22 carbon atoms, and
m is 0 or an integer greater than or equal to 1, and preferable 5 to 400, and more preferably 10 to 300. One specific example is α, ω-bismethacryloxypropyl poly-dimethylsiloxane. Another preferred example is mPDMS (monomethacryloxypropyl terminated mono-n-butyl terminated polydimethylsiloxane).
   Another useful class of non-compatabilizing silicone containing components includes silicone containing vinyl carbonate or vinyl carbamate monomers of the following formula:

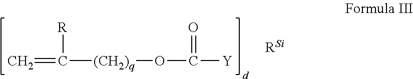

wherein: Y denotes O, S. or NH; R^{SI} denotes a silicone containing organic radical; R denotes
hydrogen or methyl; d is 1, 2, 3 or 4; and q is 0 or 1. Suitable silicone containing organic radicals R^{Si} include the following:
wherein R¹⁰ denotes:

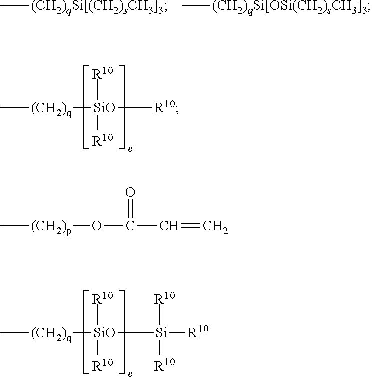

Wherein p is 1 to 6; R¹⁰ denotes an alkyl radical or a fluoroalkyl radical having 1 to 6 carbon atoms; e is 1 to 200; q is 1, 2, 3 or 4; and s is 0, 1, 2, 3, 4 or 5.
The silicone containing vinyl carbonate or vinyl carbamate monomers specifically include: 1,3-bis[4-(vinyloxycarbonyloxy)but-1-yl]tetramethyl-siloxane 3-(vinyloxycarbonylthio) propyl-[tris(trimethylsiloxysilane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate, and

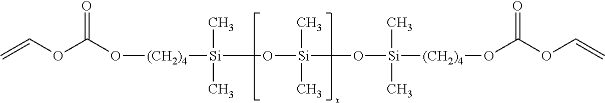

wherein x=25
Another class of non-compatabilizing silicone containing components includes compounds of the following formulae:

(*D*A*D*G)ₐ*D*D*E¹;

E(*D*G*D*A)ₐ*D*G*D*E¹ or;

E(*D*A*D*G)ₐ*D*A*D*E¹ Formulae IV-VI

wherein:

D denotes an alkyl diradical, an alkyl cycloalkyl diradical, a cycloalkyl diradical, an aryl diradical or an alkylaryl diradical having 6 to 30 carbon atoms,

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

ₐ is at least 1;

A denotes a divalent polymeric radical of formula:

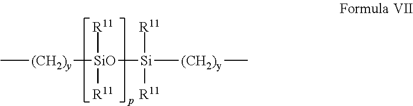

R¹¹ independently denotes an alkyl or fluoro-substituted alkyl group having 1 to 10 carbon atoms which may contain ether linkages between carbon atoms; y is at least 1; and p provides a moiety weight of 400 to 10,000; each of E and E¹ independently denotes a polymerizable unsaturated organic radical represented by formula:

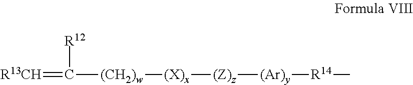

wherein: R¹² is hydrogen or methyl; R¹³ is hydrogen, an alkyl radical having 1 to 6 carbon atoms, or a —CO—Y—R¹⁵ radical wherein Y is —O—,Y—S— or —NH—; R¹⁴ is a divalent radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.
A preferred non-compatabilizing silicone containing component is represented by the following formula:

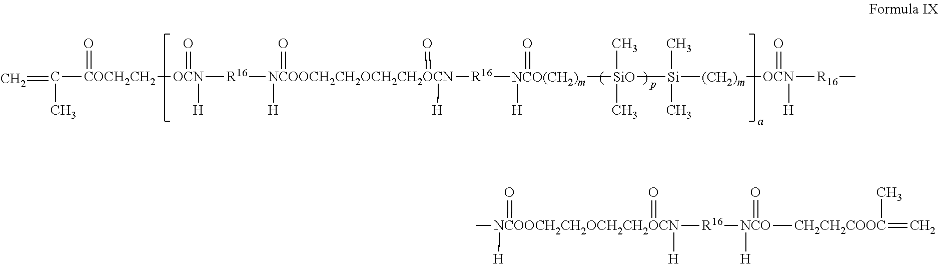

wherein R¹⁶ is a diradical of a diisocyanate after removal of the isocyanate group, such as the diradical of isophorone diisocyanate. Another preferred silicone containing macromer is compound of formula X (in which x+y is a number in the range of 10 to 30) formed by the reaction of fluoroether, hydroxy-terminated polydimethylsiloxane, isophorone diisocyanate and isocyanatoethylmethacrylate.

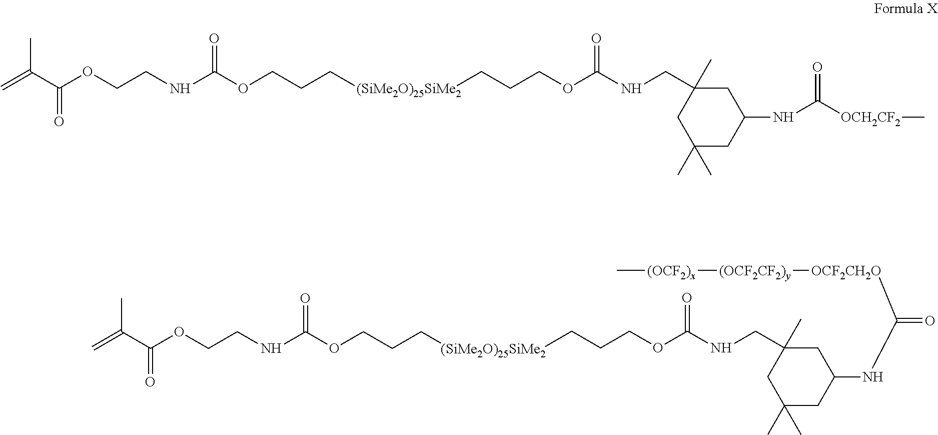

Other non-compatabilizing silicone containing components suitable for use in this invention include those described in WO 96/31792 such as macromers containing polysiloxane, polyalkylene ether, diisocyanate, polyfluorinated hydrocarbon, polyfluorinated ether and polysaccharide groups. U.S. Pat. Nos. 5,321,108; 5,387,662 and 5,539,016 describe polysiloxanes with a polar fluorinated graft or side group having a hydrogen atom attached to a terminal difluoro-substituted carbon atom. Such polysiloxanes can also be used as the silicone monomer in this invention.

### Crosslinkers

It is generally necessary to add one or more cross-linking agents, also referred to as cross-linking monomers, to the reaction mixture. Suitable crosslinkers are compounds with two or more polymerizable functional groups. The crosslinker may be hydrophilic or hydrophobic and in some embodiments of the present invention mixtures of hydrophilic and hydrophobic crosslinkers have been found to provide silicone hydrogels with improved optical clarity (reduced haziness compared to a CSI Thin Lens). Examples of suitable hydrophilic crosslinkers include compounds having two or more polymerizable functional groups, as well as hydrophilic functional groups such as polyether, amide or hydroxyl groups. Specific examples include TEGDMA (tetraethyleneglycol dimethacrylate), TrEGDMA (triethyleneglycol dimethacrylate), ethyleneglycol dimethacylate (EGDMA), ethylenediamine dimethyacrylamide, glycerol dimethacrylate and combinations thereof.

In one embodiment of the present invention, hydrophobic crosslinkers are used. Examples of suitable hydrophobic crosslinkers include multifunctional hydroxyl-functionalized silicone containing monomer, multifunctional polyether-polydimethylsiloxane block copolymers, combinations thereof and the like. Specific hydrophobic crosslinkers include acryloxypropyl terminated polydimethylsiloxane (n=10 or 20) (acPDMS), hydroxylacrylate functionalized siloxane macromer, methacryloxypropyl terminated PDMS, butanediol dimethacrylate, divinyl benzene, 1,3-bis(3-methacryloxypropyl)tetrakis(trimethylsiloxy)disiloxane and mixtures thereof. Preferred crosslinkers include acPDMS. The amount of hydrophilic crosslinker used is generally about 0 to about 2 weight % and preferably from about 0.5 to about 2 weight % and the amount of hydrophobic crosslinker is about 0 to about 5 weight %, which can alternatively be referred to in mol % of about 0.01 to about 0.2 mmole/gm reactive components, preferably about 0.02 to about 0.1 and more preferably 0.03 to about 0.6 mmole/gm. Alternatively, if the additional silicone-containing monomers act as the cross-linking agent, the addition of a crosslinking agent to the reaction mixture is optional. An example of a silicone containing monomer which can act as a crosslinking agent and, when present, does not require the addition of a crosslinking monomer to the reaction mixture includes α, ω-bismethacryloypropyl polydimethylsiloxane.

Increasing the level of crosslinker in the final polymer has been found to reduce the amount of haze. However, as crosslinker concentration increases above about 0.15 mmole/gm reactive components modulus increases above generally desired levels (greater than about 90 psi). Thus, in the present invention the crosslinker composition and amount is selected to provide a crosslinker concentration in the reaction mixture of between about 0.01 and about 0.1 mmoles/gm crosslinker.

The reactive mixture may also contain other, no-silicone monomers providing that when such monomers are polymerized with small amounts of a crosslinked, and hydrated they do not form hydrogels of 10% or greater water content. Examples of such additional monomers may include 2-hydroxypropylmethacrylate, 2-hydroxybutylmethacrylate, methylmethacrylate, and styrene.

Additional components or additives, which are generally known in the art may also be included. Additives include but are not limited to ultra-violet absorbing compounds and monomer, reactive tints, antimicrobial compounds, pigments, photochromic, release agents, combinations thereof and the like.

Additional components include other oxygen permeable components such as carbon-carbon triple bond containing monomers and fluorine containing monomers which are known in the art and include fluorine-containing (meth)acrylates, and more specifically include, for example, fluorine-containing C₂-C₁₂ alkyl esters of (meth)acrylic acid such as 2,2,2-trifluoroethyl (meth)acrylate, 2,2,2,2′,2′,2′-hexafluoroisopropyl (meth)acrylate, 2,2,3,3,4,4,4-heptafluorobutyl (meth)acrylate, 2,2,3,3,4,4,5,5,6,6,7,7,8,8,8-pentadecafluorooctyl (meth)acrylate, 2,2,3,3,4,4,5,5,6,6,7,7,8,8,9,9-hexadecafluorononyl (meth)acrylate and the like

The polymerization initiators include compounds such as lauryl peroxide, benzoyl peroxide, isopropyl percarbonate, azobisisobutyronitrile, and the like, that generate free radicals at moderately elevated temperatures, and photoinitiator systems such as aromatic alpha-hydroxy ketones, alkoxyoxybenzoins, acetophenones, acylphosphine oxides, bisacylphosphine oxides, and a tertiary amine plus a diketone, mixtures thereof and the like. Illustrative examples of photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenyl phosphineoxide (Irgacure 819), 2,4,6-trimethylbenzyldiphenyl phosphine oxide and 2,4,6-trimethylbenzoyl diphenylphosphine oxide, benzoin methyl ester and a combination of camphorquinone and ethyl 4-(N,N-dimethylamino)benzoate. Commercially available visible light initiator systems include Irgacure 819, Irgacure 1700, Irgacure 1800, Irgacure 1850 (all from Ciba Specialty Chemicals) and Lucirin TPO initiator (available from BASF). Commercially available UV photoinitiators include Darocur 1173 and Darocur 2959 (Ciba Specialty Chemicals). These and other photoinitiators which may be used are disclosed in Volume III, Photoinitiators for Free Radical Cationic & Anionic Photopolymerization, 2^{nd} Edition by J.V. Crivello & K. Dietliker; edited by G. Bradley; John Wiley and Sons; New York; 1998, which is incorporated herein by reference.

The initiator is used in the reaction mixture in effective amounts to initiate photopolymerization of the reaction mixture, e.g., from about 0.1 to about 2 parts by weight per 100 parts of reactive monomer. Polymerization of the reaction mixture can be initiated using the appropriate choice of heat or visible or ultraviolet light or other means depending on the polymerization initiator used. Alternatively, initiation can be conducted without a photoinitiator using, for example, e-beam. However, when a photoinitiator is used, the preferred initiators are bisacylphosphine oxides, such as bis(2,4,6-trimethylbenzoyl)-phenyl phosphine oxide (Irgacure 8190) or a combination of 1-hydroxycyclohexyl phenyl ketone and bis(2,6-dimethoxybenzoyl)-2, 4-4-trimethylpentyl phosphine oxide (DMBAPO), and the preferred method of polymerization initiation is visible light. The most preferred is bis(2,4,6-trimethylbenzoyl)-phenyl phosphine oxide (Irgacure 8190).

### Processing

The reaction mixtures of the present invention can be formed by any of the methods known to those skilled in the art, such as shaking or stirring, and used to form polymeric articles or devices by known methods.

The biomedical devices of the invention are prepared by mixing the non-reactive, high molecular weight hydrophilic polymer, the hydroxyl-functionalized silicone-containing monomer and the compatibilizing diluent, optionally with one or more of the following: the additional silicone containing monomers and the additives (“reactive components”), with a polymerization initiator and curing by appropriate conditions to form a product that can be subsequently formed into the appropriate shape by lathing, cutting and the like. Alternatively, the reaction mixture may be placed in a mold and subsequently cured into the appropriate article.

Various processes are known for processing the reaction mixture in the production of contact lenses, including spincasting and static casting. Spincasting methods are disclosed in U.S. Pat. Nos. 3,408,429 and 3,660,545, and static casting methods are disclosed in U.S. Pat. Nos. 4,113,224 and 4,197,266. The preferred method for producing contact lenses comprising the polymer of this invention is by the molding of the silicone hydrogels, which is economical, and enables precise control over the final shape of the hydrated lens. For this method, the reaction mixture is placed in a mold having the shape of the final desired silicone hydrogel, i.e., water-swollen polymer, and the reaction mixture is subjected to conditions whereby the monomers polymerize, to thereby produce a polymer/diluent mixture in the shape of the final desired product. Then, this polymer/diluent mixture is treated with a solvent as is known in the art to remove the diluent and ultimately replace it with water, producing a silicone hydrogel having a final size and shape which are quite similar to the size and shape of the original molded polymer/diluent article. This method can be used to form contact lenses and is further described in U.S. Pat. Nos. 4,495,313; 4,680,336; 4,889,664; and 5,039,459, incorporated herein by reference.

### Deblocking

After the lenses have been cured they are preferably removed from the mold. Unfortunately, the silicone components used in the lens formulation render the finished lenses “sticky” and difficult to release from the lens molds. Lenses can be deblocked (removed from the mold half or tool supporting the lens) using a solvent, such as an organic solvent. However, in one embodiment of the present invention at least one low molecular weight hydrophilic polymer is added to the reaction mixture, the reaction mixture is formed into the desired article, cured and deblocked in water or an aqueous solution comprising, consisting essentially of and consisting of a small amount of surfactant. The low molecular weight hydrophilic polymer can be any polymer having a structure as defined for a high molecular weight polymer, but with a molecular weight such that the low molecular weight hydrophilic polymer extracts or leaches from the lens under deblocking conditions to assist in lens release from the mold. Suitable molecular weights include those less than about 40,000 Daltons, preferably between less than about 20,000 Daltons. Those of skill in the art will appreciate that the foregoing molecular weights are averages, and that some amount of material having a molecular weight higher than the given averages may be suitable, so long as the average molecular weight is within the specified range. Preferably the low molecular weight polymer is selected from water soluble polyamides, lactams and polyethylene glycols, and mixtures thereof and more preferably poly-vinylpyrrolidone, polyethylene glycols, poly 2 ethyl-2-oxazoline (available from Polymer Chemistry Innovations, Tuscon, Ariz.), poly(methacrylic acid), poly(1-lactic acid), polycaprolactam, polycaprolactone, polycaprolactone diol, polyvinyl alcohol, poly(2-hydroxyethyl methacrylate), poly(acrylic acid), poly(1-glycerol methacrylate), poly(2-ethyl-2-oxazoline), poly(2-hydroxypropyl methacrylate), poly(2-vinylpyridine N-oxide), polyacrylamide, polymethacrylamide mixtures thereof and the like.

The low molecular weight hydrophilic polymer may be used in amounts up to about 20 wt %, more preferably in amounts between about 5 and about 20 wt % based upon the total weight of the reactive components.

Suitable surfactants include non-ionic surfactants including betaines, amine oxides, combinations thereof and the like. Examples of suitable surfactants include TWEEN® (ICI), DOE 120 (Amerchol/Union Carbide) and the like. The surfactants may be used in amounts up to about 10,000, preferably between about 25 and about 1500 ppm and more preferably between about 100 ppm and about 1200 ppm.

Suitable release agents are low molecular weight, and include 1-methyl-4-piperidone, 3-morpholino-1,2-propanediol, tetrahydro-2H-pyran-4-ol, glycerol formal, ethyl-4-oxo-1-piperidine carboxylate, 1,3-dimethyl-3,4,5,6-tetrahydro-2(1H)-pyrimidinone and 1-(2-hydroxyethyl)-2-pyrrolidone.

Lenses made from reaction mixtures without low molecular weight hydrophilic polymer may be deblocked in an aqueous solution comprising at least one organic solvent. Suitable organic solvents are hydrophobic, but miscible with water. Alcohols, ethers and the like are suitable, more specifically primary alcohols and more specifically isopropyl alcohol, DPMA, TPM, DPM, methanol, ethanol, propanol and mixtures thereof being suitable examples.

Suitable deblocking temperatures range from about ambient to about 100° C., preferably between about 70° C. and 95° C., with higher temperatures providing quicker deblocking times. Agitation, such as by sonication, may also be used to decrease deblocking times. Other means known in the art, such as vacuum nozzles may also be used to remove the lenses from the molds.

### Diluent Replacement/Hydration

Typically after curing the reaction mixture, the resulting polymer is treated with a solvent to remove the diluent (if used), unreacted components, byproducts, and the like and hydrate the polymer to form the hydrogel. Alternatively, depending on the solubility characteristics of the hydrogel's components, the solvent initially used can be an organic liquid such as ethanol, methanol, isopropanol, TPM, DPM, PEGs, PPGs, glycerol, mixtures thereof, or a mixture of one or more such organic liquids with water, followed by extraction with pure water (or physiological saline). The organic liquid may also be used as a “pre-soak”. After demolding (removing the back curve from the lens), lenses may be briefly soaked (times up to about 30 minutes, preferably between about 5 and about 30 minutes) in the organic liquid or a mixture of organic liquid and water. After the pre-soak, the lens may be further hydrated using aqueous extraction solvents.

In some embodiments, the preferred process uses an extraction solvent that is predominately water, preferably greater than 90% water, more preferably greater than 97% water. Other components may include salts such as sodium chloride, sodium borate boric acid, DPM, TPM, ethanol or isopropanol. Lenses are generally released from the molds into this extraction solvent, optionally with stirring or a continuous flow of the extraction solvent over the lenses. This process can be conducted at temperatures from about 2 to about 121° C., preferably from about 20 to about 98° C. The process can be conducted at elevated pressures, particularly when using temperatures in excess of about 100° C., but is more typically conducted at ambient pressures. It is possible to deblock the lenses into one solution (for example containing some release aid) and then transfer them into another (for example the final packing solution), although it may also be possible to deblock the lenses into the same solution in which they are packaged. The treatment of lenses with this extraction solvent may be conducted for a period of from about 30 seconds to about 3 days, preferably between about 5 and about 30 minutes. The selected hydration solution may additional comprise small amounts of additives such as surfactants. Suitable surfactants include non-ionic surfactants, such as betaines and amine oxides. Specific surfactants include TWEEN 80 (available from Amerchol), DOE 120 (available from Union Carbide), Pluronics, methyl cellulose, mixtures thereof and the like and may be added in amounts between about 0.01 weight % and about 5 weight % % based upon total weight of hydration solution used.

In one embodiment the lenses may be hydrated using a “step down” method, where the solvent is replaced in steps over the hydration process. Suitable step down processes have at least two steps, where a percentage of the solvent is replaced with water. Further details on the methods of producing silicone hydrogel contact lenses are disclosed in U.S. Pat. Nos. 4,495,313; 4,680,336; 4,889,664; and 5,039,459, which are hereby incorporated by reference.

The biomedical devices, and particularly ophthalmic lenses of the present invention have a balance of properties which makes them particularly useful. Such properties include clarity, water content, oxygen permeability and contact angle. Thus, in one embodiment, the biomedical devices are contact lenses having a water content of greater than about 17%, preferably greater than about 20% and more preferably greater than about 25%. The ophthalmic devices of the present invention also display low haze, good wettability and modulus.

As used herein clarity means substantially free from visible haze. Preferably clear lenses have a haze value of less than about 150%, more preferably less than about 100%.

Suitable oxygen permeabilities are preferably greater than about 40 barrer and more preferably greater than about 60 barrer.

Also, the biomedical devices, and particularly ophthalmic devices and contact lenses have contact angles (advancing) which are less than about 80°, preferably less than about 70° and more preferably less than about 65°. In some preferred embodiments the articles of the present invention have combinations of the above described oxygen permeability, water content and contact angle. All combinations of the above ranges are deemed to be within the present invention.

### Haze Measurement

Haze is measured by placing a hydrated test lens in borate buffered saline in a clear 20×40×10 mm glass cell at ambient temperature above a flat black background, illuminating from below with a fiber optic lamp (Titan Tool Supply Co. fiber optic light with 0.5″ diameter light guide set at a power setting of 4-5.4) at an angle 66° normal to the lens cell, and capturing an image of the lens from above, normal to the lens cell with a video camera (DVC 1300C:19130 RGB camera with Navitar TV Zoom 7000 zoom lens) placed 14 mm above the lens platform. The background scatter is subtracted from the scatter of the lens by subtracting an image of a blank cell using EPIX XCAP V 1.0 software. The subtracted scattered light image is quantitatively analyzed, by integrating over the central 10 mm of the lens, and then comparing to a −1.00 diopter CSI Thin Lens®, which is arbitrarily set at a haze value of 100, with no lens set as a haze value of 0. Five lenses are analyzed and the results are averaged to generate a haze value as a percentage of the standard CSI lens. Preferably, lenses have haze levels of less than about 150% (of CSI as set forth above) and more preferably less than about 100%.

### Water Content

The water content of contact lenses was measured as follows: Three sets of three lenses are allowed to sit in packing solution for 24 hours. Each lens is blotted with damp wipes and weighed. The lenses are dried at 60° C. for four hours at a pressure of 0.4 inches Hg or less. The dried lenses are weighed. The water content is calculated as follows:

$$\% water con tent = \frac{( wet weight - dry weight )}{wet weight} \times 100$$

The average and standard deviation of the water content are calculated for the samples and are reported.

### Modulus

Modulus is measured by using the crosshead of a constant rate of movement type tensile testing machine equipped with a load cell that is lowered to the initial gauge height. A suitable testing machine includes an Instron model 1122. A dog-bone shaped sample having a 0.522 inch length, 0.276 inch “ear” width and 0.213 inch “neck” width is loaded into the grips and elongated at a constant rate of strain of 2 in/min. until it breaks. The initial gauge length of the sample (Lo) and sample length at break (Lf) are measured. Twelve specimens of each composition are measured and the average is reported. Percent elongation is =[(Lf−Lo)/Lo]×100. Tensile modulus is measured at the initial linear portion of the stress/strain curve.

### Advancing Contact Angle

The advancing contact angle was measured as follows. Four samples from each set were prepared by cutting out a center strip from the lens approximately 5 mm in width and equilibrated in packing solution. The wetting force between the lens surface and borate buffered saline is measured at 23° C. using a Wilhelmy microbalance while the sample is being immersed into or pulled out of the saline. The following equation is used

F=2γp cos θ or θ=cos⁻1(F/2γp)

where F is the wetting force, γ is the surface tension of the probe liquid, p is the perimeter of the sample at the meniscus and θ is the contact angle. The advancing contact angle is obtained from the portion of the wetting experiment where the sample is being immersed into the packing solution. Each sample was cycled four times and the results were averaged to obtain the advancing contact angles for the lens.

### Dk

The Dk is measured as follows. Lenses are positioned on a polarographic oxygen sensor consisting of a 4 mm diameter gold cathode and a silver ring anode then covered on the upper side with a mesh support. The lens is exposed to an atmosphere of humidified 2.1% O₂. The oxygen that diffuses through the lens is measured by the sensor. Lenses are either stacked on top of each other to increase the thickness or a thicker lens is used. The L/Dk of 4 samples with significantly different thickness values are measured and plotted against the thickness. The inverse of the regressed slope is the Dk of the sample. The reference values are those measured on commercially available contact lenses using this method. Balafilcon A lenses available from Bausch & Lomb give a measurement of approx. 79 barrer. Etafilcon lenses give a measurement of 20 to 25 barrer. (1 barrer=10¹⁰ (cm³ of gas×cm²)/(cm³ of polymer×sec×cm Hg)).

The Examples below further describe this invention, but do not limit the invention. They are meant only to suggest a method of practicing the invention. Those knowledgeable in the field of contact lenses as well as other specialties may find other methods of practicing the invention. However, those methods are deemed to be within the scope of this invention.

Some of the materials that are employed in the Examples are identified as follows:
DMA N,N-dimethylacrylamide
mPDMS 800-1000 MW (Mₙ) monomethacryloxypropyl terminated mono-n-butyl terminated polydimethylsiloxane
HO-PDMS mono-(2-hydroxy-3-methacryloxypropyl)-propyl ether terminated polydimethylsiloxane (400-1000 MW))
Norbloc 2-(2′-hydroxy-5-methacrylyloxyethylphenyl)-2H-benzotriazole
PVP poly(N-vinyl pyrrolidone) (K value 90)
IPA isopropyl alcohol
D3O 3,7-dimethyl-3-octanol
TEGDMA tetraethyleneglycol dimethacrylate
CGI 819 bis(2,4,6-trimethylbenzoyl)-phenyl phosphine oxide

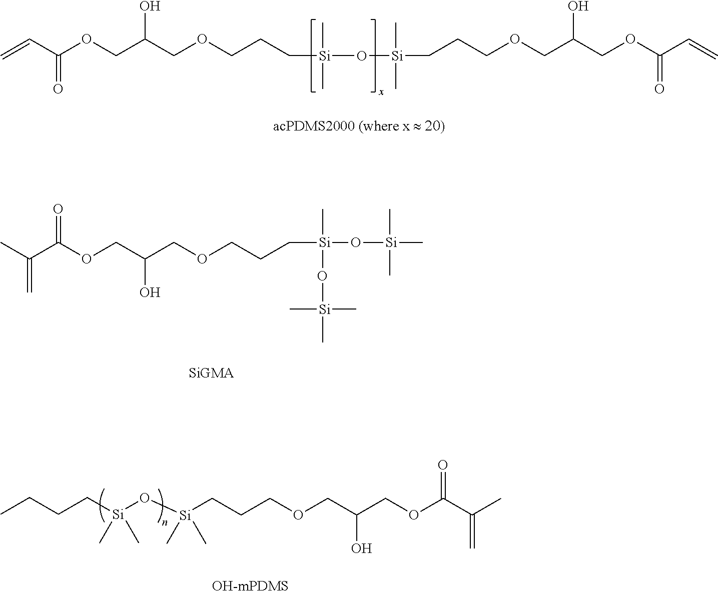

### Examples 1-4

The clear blends in Table 1 were formed by combining all components and mixing overnight at room temperature. (The amount of all lens components is provided in weight %. The % diluent is provided as a weight % of the combination of lens components and diluent.) The blends were deoxygenated by placing under vacuum, then backfilling with N₂ gas. Lenses were made using molds made from Zeonor (front half) and polypropylene (back). Before forming lenses the molds were stored in a nitrogen environment overnight. In a N₂ filled box, 75 μl of the blend is transferred into each of the front mold halves, and quartz plates were placed on the closed molds. The mold were closed and irradiated at 55-60° C. for 15 minutes using Philips TL 20W/03T fluorescent bulbs to provide about 1-1.5 mW/cm² light at the mold. The molds were opened and the lenses were released into a 70/30 (vol) solution of IPA and water. The solution was replaced three times to extract the lenses. The lenses were then placed sequentially into 30/70 and 10/90 solutions of IPA and water, followed by deionized water (with one exchange) and borate buffered saline (with one exchange). Lenses were autoclaved in borate buffered saline before testing. The appearance of the lenses made in Examples 1-4 is listed in the last row of Table 1.

TABLE 1

| Material | Example 1 | Example 2 | Example 3 | Example 4 |
|---|---|---|---|---|
| SiGMA | 64.5 | 55 | 55 | 55 |
| mPDMS | 0 | 12.5 | 12.5 | 12.5 |
| 1000 | | | | |
| acPDMS | 13 | 5 | 5 | 5 |
| 2000 | | | | |
| TEGDMA | 0 | 0 | 0 | 0 |
| Norbloc | 2.2 | 2.2 | 2.2 | 2.2 |
| PVP K90 | 20 | 15 | 15 | 15 |
| PVP K30 | 0 | 10 | 10 | 10 |
| CGI 819 | 0.33 | 0.33 | 0.33 | 0.33 |
| % Diluent | 25 | 25 | 25 | 25 |
| Diluent | D3O | t-amylalcohol | 1:1 (wt) | 1:1 (wt) |
| | | | t-amylalcohol | t-amylalcohol |
| | | | and D3O | and capric acid |
| Lens | Clear, | hazy, | Clearer than | hazy, |
| appear- | lubricious, | lubricious and | Ex. 2, splotchy | lubricious |
| ance | wettable, | wettable | patches visible | and wettable |
| | some grit- | | under | |
| | like visual | | illumination | |
| | defects | | | |

### Examples 5 and 6

Lenses were made using the formulations in Table 2, and the procedure from EXAMPLE 1. The resulting lenses were sticky, semi-solid lenses which were not further processed. Examples 5 and 6 show that increasing the diluent to 30 wt % or more creates sticky, semi-solid lenses which are difficult to process.

TABLE 2

| Material | Example 5 | Example 6 |
|---|---|---|
| SiGMA | 57.4 | 57.4 |
| mPDMS 1000 | 15 | 15 |
| acPDMS 2000 | 5 | 5 |
| TEGDMA | 0 | 0 |
| Norbloc | 2.2 | 2.2 |
| PVP K90 | 20 | 20 |
| PVP K30 | 0 | 0 |
| CGI 819 | 0.33 | 0.33 |
| % Diluent | 30 | 40 |
| Diluent | 3:2 t-amyl alcohol and | 3:2 t-amyl alcohol |
| | D3O | and D3O |

### Examples 7 and 8

Lenses were made from the formulations in Table 3, using the procedure of Example 1. The properties of the resulting lenses are shown in Table 4.

TABLE 3

| Material | Example 7 | Example 8 |
|---|---|---|
| OH-mPDMS, n = 4 | 65 | 65 |
| mPDMS 1000 | 11.5 | 11.5 |
| acPDMS 1000 | 5 | 0 |
| acPDMS 2000 | 0 | 5 |
| TEGDMA | 1.75 | 1.75 |
| Norbloc | 2.2 | 2.2 |
| PVP K90 | 14.8 | 14.8 |
| CGI 819 | 0.28 | 0.28 |
| % Diluent | 24 | 24 |
| Diluent | 3:2 t-amyl alcohol and | 3:2 t-amyl alcohol |
| | capric acid | and capric acid |

TABLE 4

| | Example 7 | Example 8 |
|---|---|---|
| % Water content | 18 | 19 |
| Tensile strength (psi) | 112 | 156 |
| Modulus (psi) | 336 | 254 |
| % Elongation at break | 69 | 154 |
| Toughness (in.#/in²) | 41 | 136 |
| Haze | 19% | 6% |
| Dk, barrers | NM | 245 |

NM means not measured

Examples 7 and 8 show that silicone hydrogels having a desirable balance of properties may be made from reaction mixtures which do not comprise any reactive hydrophilic components.

### Examples 9 and 10

Lenses were made from the formulations in Table 5, using the procedure of Example 1. The lenses were lubricious and generally clear, though the Example 10 lens was slightly hazy.

TABLE 5

| Material | Example 9 | Example 10 |
|---|---|---|
| OH-mPDMS, n = 4 | 72.5 | 67.5 |
| acPDMS 1000 | 5 | 0 |
| acPDMS 2000 | 0 | 10 |
| Norbloc | 2.2 | 2.2 |
| PVP K90 | 20 | 20 |
| CGI 819 | 0.3 | 0.3 |
| % Diluent | 24 | 24 |
| Diluent | 3:2 t-amyl alcohol | 3:2 t-amyl alcohol |
| | and capric acid | and capric acid |

### Examples 11-16

Blends were made from the formulations listed in Table 6 using a 3:2 mixture of t-amyl alcohol and capric acid, with heating at 40° to dissolve. Lenses were made using procedure form EXAMPLE 1. Lenses of Examples 11 and 12 showed some haziness and were tacky. Lenses of Examples 13-16 were generally clear, with slightly less haze as amount of diluent decreased.

TABLE 6

| Material | Ex 11 | Ex 12 | Ex 13 | Ex 14 | Ex 15 | Ex 16 |
|---|---|---|---|---|---|---|
| OH-mPDMS, n = 4 | 65 | 65 | 65 | 65 | 65 | 65 |
| mPDMS 1000 | 10.5 | 9.5 | 11 | 11 | 11 | 11 |
| acPDMS 1000 | 4.5 | 4.5 | 6.25 | 6.25 | 6.25 | 6.25 |
| TEGDMA | 1.75 | 1.75 | 0 | 0 | 0 | 0 |
| Norbloc | 2 | 2 | 2 | 2 | 2 | 2 |
| PVP K90 | 16 | 17 | 15.5 | 15.5 | 15.5 | 15.5 |
| CGI 819 | 0.25 | 0.25 | 0.25 | 0.25 | 0.25 | 0.25 |
| % Diluent | 25 | 25 | 24 | 22.5 | 20 | 17.5 |

### Examples 17-19

Blends were made from the formulations shown in Table 7 with 3:2 (wt) t-amyl alcohol and capric acid as diluent and with heating at 40° to dissolve. Lenses were made using procedure from Example 1, except curing was conducted at an intensity of ˜5-6 mW/cm². Lenses were clear.

TABLE 7

| Material | Ex. 17 | Ex. 18 | Ex. 19 |
|---|---|---|---|
| OH-mPDMS, | 56.5 | 53.5 | 50.5 |
| n = 4 | | | |
| mPDMS 1000 | 20 | 23 | 26 |
| acPDMS | 6.25 | 6.25 | 6.25 |
| 1000 | | | |
| Norbloc | 2.0 | 2.0 | 2.0 |
| PVP K90 | 15 | 15 | 15.5 |
| CGI 819 | 0.25 | 0.25 | 0.25 |
| % Diluent | 17.5 | 17.5 | 17.5 |
| appearance | Clear | Hazy | Slight haze |

### Examples 20-27

Blends are made from the formulations shown in Table 8 with 17.5 wt % of a 3:2 (wt) t-amyl alcohol and capric acid mixture as diluent and with heating at 40° to dissolve. Lenses are made using procedure from Example 1, except curing is conducted at an intensity of ˜5-6 mW/cm².

TABLE 8

| Material | Ex 20 | Ex 21 | Ex 22 | Ex 23 | Ex 24 | Ex 25 | Ex 26 | Ex 27 |
|---|---|---|---|---|---|---|---|---|
| OH-mPDMS, | 56.5 | 56.5 | 56.5 | 56.5 | 57.5 | 58.5 | 59.5 | 60.5 |
| n = 4 | | | | | | | | |
| mPDMS | 21 | 22 | 23 | 24 | 20 | 20 | 20 | 20 |
| 1000 | | | | | | | | |
| acPDMS | 5.25 | 4.25 | 3.25 | 2.25 | 5.25 | 4.25 | 3.25 | 2.25 |
| 1000 | | | | | | | | |
| Norbloc | 2 | 2 | 2 | 2 | 2 | 2 | 2 | 2 |
| PVP K90 | 15 | 15 | 15 | 15 | 15 | 15 | 15 | 15 |
| CGI 819 | 0.25 | 0.25 | 0.25 | 0.25 | 0.25 | 0.25 | 0.25 | 0.25 |
| % Diluent | 17.5 | 17.5 | 17.5 | 17.5 | 17.5 | 17.5 | 17.5 | 17.5 |

The blends are homogeneous and formed lenses upon curing.

We claim:

1. A silicone hydrogel formed from a reaction mixture consisting essentially of one or more non-reactive, hydrophilic high molecular weight polymers, one or more hydroxyl-functionalized silicone containing monomers, one or more crosslinkers, and at least one compatabilizing diluent.

2. The silicone hydrogel of claim 1 wherein said hydroxyl-functionalized silicone containing monomer comprises at least one polymerizable group and has an average molecular weight of about less than 5000 Daltons.

3. The silicone hydrogel of claim 1 wherein said hydroxyl-functionalized silicone containing monomer comprises a ratio of Si to OH of less than about 15:1.

4. The silicone hydrogel of claim 1 wherein said hydroxyl-functionalized silicone containing monomer comprises a ratio of Si to OH of between about 1:1 to about 10:1.

5. The silicone hydrogel of claim 1 wherein said hydroxyl-functionalized silicone-containing monomer is a compound of Formula I or II 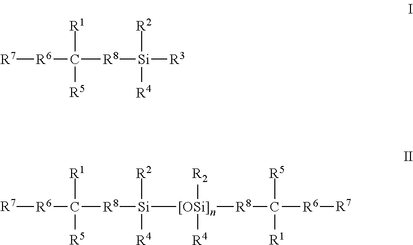
wherein:
n is an integer between 3 and 35
R¹ is hydrogen, C₁₋₆alkyl,
R², R³, and R⁴, are independently, C₁₋₆alkyl, triC₁₋₆alkylsiloxy, phenyl, naphthyl, substituted C₁₋₆alkyl, substituted phenyl, or substituted naphthyl
where the alkyl substitutents are selected from one or more members of the group consisting of C₁₋₆alkoxycarbonyl, C₁₋₆alkyl, C₁₋₆alkoxy, amide, halogen, hydroxyl, carboxyl, C₁₋₆alkylcarbonyl and formyl, and
where the aromatic substitutents are selected from one or more members of the group consisting of C₁₋₆alkoxycarbonyl, C₁₋₆alkyl, C₁₋₆alkoxy, amide, halogen, hydroxyl, carboxyl, C₁₋₆alkylcarbonyl and formyl;
R⁵ is a hydroxyl, an alkyl group containing one or more hydroxyl groups; or
(CH₂(CR⁹R¹⁰)_{y}O)ₓ)—R¹¹ wherein y is 1 to 5, preferably 1 to 3, x is an integer of 1 to 100, preferably 2 to 90 and more preferably 10 to 25; R⁹-R¹¹ are independently selected from H, alkyl having up to 10 carbon atoms and alkyls having up to 10 carbon atoms substituted with at least one polar functional group,
R⁶ is a divalent group comprising up to 20 carbon atoms;
R⁷ is a monovalent group that can undergo free radical or cationic polymerization, comprising up to 20 carbon atoms; and
R⁸ is a divalent or trivalent group comprising up to 20 carbon atoms.

6. The biomedical device of claim 1 wherein said hydroxyl-functionalized silicone-containing monomer is selected from the group consisting of 2-propenoic acid, 2-methyl-2-hydroxy-3-[3-[1,3,3,3-tetramethyl-1-[trimethylsilyl)oxy]disiloxanyl]propoxy]propyl ester, (3-methacryloxy-2-hydroxypropyloxy)propyltris(trimethylsiloxy)silane, (2-methacryloxy-3-hydroxypropyloxy)propylbis(trimethylsiloxy)methylsilane, mono-(2-hydroxy-3-methacryloxypropyl)-propyl ether terminated polydimethylsiloxane (400-1000 MW)), and mixtures thereof.

7. The biomedical device of claim 1 wherein said hydroxyl-functionalized silicone-containing monomer comprises at least one a hydroxyl functionalized polydialkyl siloxane.

8. The biomedical device of claim 1 wherein said at least one a hydroxyl functionalized polydialkyl siloxane is selected from 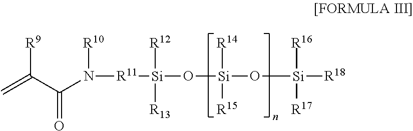
wherein R⁹ represents a hydrogen atom or a methyl group;
R¹⁰ represents a hydrogen atom or an alkyl or an aryl group with between 1 and 20 carbon atoms which may be substituted with hydroxyl, acid, ester, ether, thiol and combinations thereof;
R¹¹ represents a C₁₋₁₀ alkylene group or arylene group that may be substituted with hydroxyl acid, ester, ether, thiol and combinations thereof; wherein at least one of either R¹⁰ or R¹¹ contains a hydroxyl group;
R¹² to R¹⁸ independently represent a C₁₋₂₀ alkyl group or an aryl group with between 1 and 20 carbon atoms, either of which may be substituted with fluorine, hydroxyl, acid, ester, ether, thiol and combinations thereof, and n is an integer in a range from 1 to 10.

9. The biomedical device of claim 7 wherein hydroxyl functionalized polydialkyl siloxane is selected from mono (meth)acrylamide terminated, hydroxyl functionalized polydialkyl siloxane of Formulae IV through V. 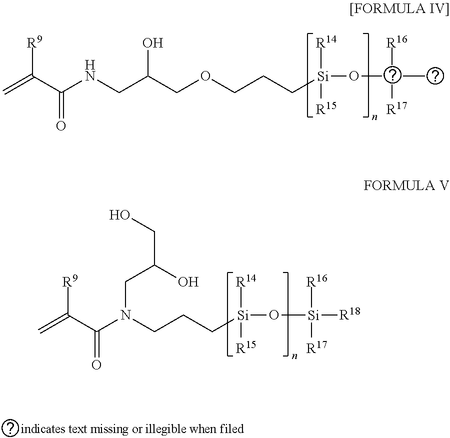
wherein R⁹ is a hydrogen atom or a methyl group;
R¹⁴ to R¹⁸ are independently selected from alkyl groups having between 1 and 20 carbon atoms or aryl groups having between 6 and 20 carbon atoms and n is a natural number in the range from 1 to 50.

10. The biomedical device of claim 8 wherein R¹⁴ to R¹⁷ are independently methyl and R¹⁸ is selected from the group consisting of alkyl group with between 1 and 4 carbon atoms.

11. The biomedical device of claim 7 wherein hydroxyl functionalized silicone containing monomer is selected from a (meth)acrylamide of Formulae VI or VII. 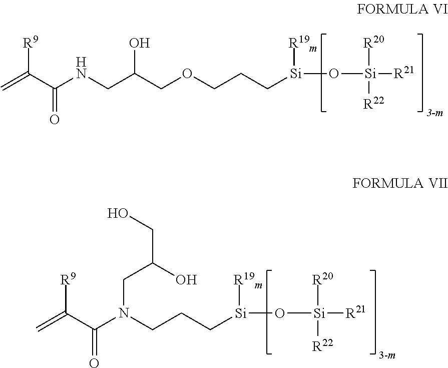
wherein R⁹ is a hydrogen or a methyl group;
R¹⁹ through R²² are independently selected from the group consisting of alkyl groups having between 1 and 10 carbon atoms and aryl groups with between 6 and 10 carbon and n is an integer in the range from 1 to 50, m is an integer from 0 to 2.

12. The biomedical device of claim 12 wherein R¹⁹ through R²² are independently selected from the group consisting of atoms is more preferable, alkyl groups with between 1 and 4 carbon atoms; n is 2 and 30, m is 0 or 1.

13. The biomedical device of claim 12 wherein R¹⁹ through R²² are methyl; n is an integer between 3 and 10.

14. The biomedical device of claim 1 wherein said compatibilizing diluent has an alpha value between about 0.05 and about 1 and a Hansen solubility parameter, δp less than about 10.

15. The biomedical device of claim 1 wherein said compatibilizing diluent has an alpha value between about 0.1 and about 0.9 and a δp less than about 6.

16. The biomedical device of claim 1 wherein said compatibilizing diluent is selected from the group consisting of 1-ethoxy-2-propanol, diisopropylaminoethanol, isopropanol, 3,7-dimethyl-3-octanol, 1-decanol, 1-dodecanol, 1-octanol, 1-pentanol, 2-pentanol, 1-hexanol, 2-hexanol, 2-octanol, 3-methyl-3-pentanol, tert-amyl alcohol, tert-butanol, 2-butanol, 1-butanol, 2-methyl-2-pentanol, 2-propanol, 1-propanol, ethanol, 2-ethyl-1-butanol, SiGMA acetate, 1-tert-butoxy-2-propanol, 3,3-dimethyl-2-butanol, tert-butoxyethanol, 2-octyl-1-dodecanol, decanoic acid, octanoic acid, dodecanoic acid, 2-(diisopropylamino)ethanol and mixtures thereof.

17. The biomedical device of claim 1 wherein said compatibilizing diluent is selected from the group consisting of 3,7-dimethyl-3-octanol, 1-dodecanol, 1-decanol, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, 2-methyl-2-pentanol, 2-ethyl-1-butanol, ethanol, 3,3-dimethyl-2-butanol, 2-octyl-1-dodecanol, decanoic acid, octanoic acid, dodecanoic acid, and mixtures thereof.

18. The biomedical device of claim 1 wherein said compatibilizing diluent is selected from the group consisting of 3,7-dimethyl-3-octanol, 1-dodecanol, 1-decanol, 1-octanol, 1-pentanol, 1-hexanol, 2-hexanol, 2-octanol, 1-dodecanol, 3-methyl-3-pentanol, 1-pentanol, 2-pentanol, t-amyl alcohol, tert-butanol, 2-butanol, 1-butanol, 2-methyl-2-pentanol, 2-ethyl-1-butanol, 3,3-dimethyl-2-butanol, 2-octyl-1-dodecanol, and mixtures thereof.

19. The biomedical device of claim 1 wherein said compatibilizing diluent comprises t-amyl alcohol and decanoic acid.

20. The biomedical device of claim 1 wherein said reaction mixture further comprises at least one silicone containing crosslinker.

21. The biomedical device of claim 1 wherein said hydrophilic polymer is selected from the group consisting of polyamides, polylactones, polyimides, polylactams, functionalized polyamides, functionalized polylactones, functionalized polyimides, functionalized polylactams, and mixtures thereof.

22. The biomedical device of claim 1 wherein said hydrophilic polymer is selected from the group consisting of poly-N-vinyl pyrrolidone, poly-N-vinyl-2-piperidone, poly-N-vinyl-2-caprolactam, poly-N-vinyl-3-methyl-2-caprolactam, poly-N-vinyl-3-methyl-2-piperidone, poly-N-vinyl-4-methyl-2-piperidone, poly-N-vinyl-4-methyl-2-caprolactam, poly-N-vinyl-3-ethyl-2-pyrrolidone, and poly-N-vinyl-4,5-dimethyl-2-pyrrolidone, polyvinylimidazole, poly-N—N-dimethylacrylamide, polyvinyl alcohol, polyacrylic acid, polyethylene oxide, poly 2 ethyl oxazoline, heparin polysaccharides, polysaccharides, mixtures and copolymers thereof.

23. The biomedical device of claim 1 wherein said hydrophilic polymer comprises poly-N-vinylpyrrolidone.

24. The biomedical device of claim 1 comprising about 14 to about 25 weight % high molecular weight hydrophilic polymer

25. The biomedical device of claim 1 comprising about 15 to about 25 weight % high molecular weight hydrophilic polymer.

26. The biomedical device of claim 1 further comprising a second hydrophilic polymer having a molecular weight less than about 50,000 Daltons.

27. The biomedical device of claim 1 wherein said hydroxyl-functionalized silicone containing monomer is present in the reaction mixture in an amount between about 40 to about 80 weight percent, based on the weight percentage of all reactive components.

28. The biomedical device of claim 1 wherein said hydroxyl-functionalized silicone containing monomer is present in the reaction mixture in an amount between about 50 to about 75 weight percent, based on the weight percentage of all reactive components.

29. A silicone hydrogel formed from a reaction mixture comprising one or more non-reactive, hydrophilic high molecular weight polymers, one or more hydroxyl-functionalized silicone containing monomers, one or more crosslinkers, and at least one compatabilizing diluent, provided however, that said reaction mixture is free of reactive hydrophilic components.
